(19) United States
(12) Patent Application Publication
(10) Pub. No.: US 2017/0240840 A1
(43) Pub. Date: Aug. 24, 2017

(54) EXTRACTION OF OILS FROM BIOMASS SOLIDS USING VARYING TEMPERATURE PRESSURE AND SOLVENT MATERIALS

(71) Applicant: PREPROCESS INC., San Ramon, CA (US)

(72) Inventors: Marc Philip Privitera, Walnut Creek, CA (US); Christina Metz Borgese, San Ramon, CA (US)

(73) Assignee: PREPROCESS INC., San Ramon, CA (US)

(21) Appl. No.: 15/438,517

(22) Filed: Feb. 21, 2017

Related U.S. Application Data
(60) Provisional application No. 62/297,016, filed on Feb. 18, 2016.

(51) Int. Cl. C11B 1/10; B33Y 70/00; C11B 1/04

(52) U.S. Cl. CPC C11B 1/10; C11B 1/04; B33Y 70/00

(57) ABSTRACT

Apparatuses and methods for extracting desired oils, resins, and/or solids from biomass. An aspect of the present disclosure comprises a continuous flow system using solvents as a carrier liquid and then converting the solvent to a supercritical state for extraction of the desired materials through pressure, temperature, and volume control within the extraction system.

### FIELD

Aspects of the present disclosure generally relate to extracting materials, and more particularly to extraction of oils from biomass solids.

### BACKGROUND

Reference may be made herein to other United States Patents, foreign patents, and/or other technical references. Any reference made herein to other documents is an express incorporation by reference of the document so named in its entirety.

Recent advances in chemical processes allow for extraction of materials from various materials. An example of such advances is extraction of oils and resins from biological materials for use in making biodegradable plastics.

Plastic resins are used for many products, as plastic is moldable and can be tailored to have specific tensile and shear strengths for various applications. Plastics often come from petroleum or other oil-based materials. However, because of the increased costs of petroleum products, and the ecological effects of non-biodegradable plastics, there have been recent attempts at manufacturing biodegradable plastics, which are often referred to as “bioplastics.” Many of these attempts have been accompanied with high cost, low recycling yield, and other barriers to entry for a bioplastic facility. As such, the ability of bioplastics to compete with petroleum-based plastics has not yet been fully achieved. The process of producing specific types of resins or oils from a biomass of material, e.g., polyhydroxyalkanoate (PHA) resins, can be tailored to produce specific types of resins with specific properties from various biomass feedstocks.

As with bioplastics, other oils and resins may be extracted from biomass solids (which may include liquids and/or fluids, either as a feedstock or as a by-product of the process), depending on the solids used and the desired extract.

### SUMMARY

The present disclosure describes methods and apparatuses for extracting oils and/or other materials from biomass materials.

A method for processing biomass in accordance with an aspect of the present disclosure comprises analyzing an input material, processing the input material based at least in part on the analysis of the input material, analyzing the processed input material, distilling the analyzed process input material based at least in part on the analysis of the processed input material, analyzing the distilled processed input material, and separating the analyzed distilled processed input material based at least in part on the analysis of the distilled processed input material.

Such a method further optionally includes the input material being a cannabis strain, at least one of the processing, distilling, and/or separating being based at least in part on an amount of input material to be processed, filtering at least one of the processed input material, the distilled processed input material, and the separated analyzed distilled processed input material, changing the filtering based at least in part on at least one of the analyzing of the input material, the analyzing of the processed input material, and the analyzing of the distilled processed input material, separating the input material into at least two components of the input material, the separated analyzed processed input material being a cannabinoid, the separated analyzed processed input material being a food stuff, the separated analyzed processed input material being at least one of an alcohol and a fatty acid functional solvent, the separated analyzed processed input material being a three-dimensional printing material, and the separated analyzed processed input material is a cannabis functional material.

A system in accordance with an aspect of the present disclosure comprises a first analyzer for analyzing an input material, an apparatus for processing the input material based at least in part on an output of the first analyzer, a second analyzer for analyzing the processed input material, a distiller for distilling the analyzed process input material based at least in part on an output of the second analyzer, a third analyzer for analyzing the distilled processed input material, and a separator for separating the analyzed distilled processed input material based at least in part on an output of the third analyzer.

Such a system optionally further comprises the input material being a cannabis strain, a parameter for at least one of the distiller, the apparatus, and the separator being changed based at least in part on an amount of input material to be processed by the system, a filter for filtering at least one of the processed input material, the distilled processed input material, and the separated analyzed distilled processed input material, the apparatus separating the input material into at least two components of the input material, the separated analyzed processed input material being a cannabinoid, the separated analyzed processed input material being a food stuff, the separated analyzed processed input material being at least one of an alcohol and a fatty acid functional solvent, and the separated analyzed processed input material is at least one of a three-dimensional printing material and a cannabis functional material.

The above summary has outlined, rather broadly, some features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same or similar purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a process flow diagram for producing essential oils in an aspect of the present disclosure.

FIG. 2 illustrates a process flow in an aspect of the present disclosure.

FIG. 3 illustrates an example of an analyzer in accordance with an aspect of the present disclosure.

FIG. 4 illustrates the fermentation process in accordance with an aspect of the present disclosure.

FIG. 5 illustrates an apparatus in accordance in accordance with an aspect of the present disclosure.

FIG. 6 illustrates a slurry analyzer in accordance with an aspect of the present disclosure.

FIG. 7 illustrates a process flow diagram illustrating a method for producing oils in accordance with an aspect of the present disclosure.

FIG. 8 illustrates a process flow for extraction of ethanol in accordance with an aspect of the present disclosure.

FIG. 9 illustrates separate processing steps for different constituent parts of a biomass in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

### Overview

Recently, certain biomass materials have become legalized in certain jurisdictions. The plant family Cannabaceae, including the species Cannibis, having three species, i.e., cannabis sativa, cannabis indica, and cannabis ruderalis, has been legalized for personal use in several state jurisdictions. In Colorado, for example, approximately 700 million dollars worth of Cannabis was sold during 2014.

Cannabis is grown and harvested as a multi-component field crop. The plant can be divided into fiber, seeds and flowers. Each of these parts have different potential uses in commerce, and, as such, each part and/or combination of parts may undergo different chemical and/or mechanical processing techniques in order to extract, separate and refine various constituents of the plant. In addition the cannabis plant, both indica and sativa offer functionality for chemical engineering operations not yet available from traditional materials.

Because of the newly acquired legal status for the recreational use of cannabis, growers and farmers have begun hybridizing cannabis plants to increase and/or alter the amount of the active ingredients in cannabis plants. One of the more well-known active ingredients is known as Delta-9 tetrahydrocannabinol, more commonly referred to as “THC.”

The hybridization of various strains of cannabis is done to produce various levels of cannabinoids and/or other chemical compounds, e.g., Cannabinol (CBN), Delta-8 tetrahydrocannabinol, Cannabinodiol (CBND), Cannabichromene (CBC), Delta-9 tetrahydrocannabinol, Cannabidiolic acid (CBDA), Cannabidivarin (CBDV), Cannabidivarinic acid (CBDVA), Cannabicyclol (CBL), Cannabinol methylether (CBNM), terpinoids, fatty acids, flavonoids, phenols, etc. A list of some of the cannabinoids and/or other chemical compounds that may be present in a given strain of cannabis may be found in Forensic Science and Medicine: Marijuana and the Cannabinoids, M. A. ElSohly, Ed., Humana Press Inc., Totowa, N.J., which is expressly incorporated by reference herein. Each cannabinoid may provide antiemetic, euphoric, anti-inflammatory, analgesic, and/or antioxidant pharmacological effects to a person that ingests a substance containing that specific cannabinoid. Further, combinations of cannabinoids may have other and/or additional pharmacological effects.

To change various cannabinoid and/or other chemical compound levels in a cannabis plant, a strain of cannabis sativa may be hybridized with a strain of cannabis indicia. Although this hybridization may control a specific cannabinoid and/or chemical compound level, other cannabinoids that contribute to the overall pharmacological effect of the hybridized plant may be removed and/or reduced, thereby rendering the hybridized plant less suitable than desired.

Other approaches have been undertaken to extract specific cannabinoids and/or other chemical compounds from biomass solids. The cannabis plants are directly exposed to solvents, such as butane, and the oils and resins e.g., butane honey oil (BHO), shatter, etc., from the cannabis plants are extracted. With such approaches, however, at least some of the solvent remains in the final product, and is thus consumed along with the cannabinoids. The pharmacological effects of the solvents may add to those of the cannabinoids, however, the pharmacological effects of the solvents are often harmful to humans. Further, the open exposure of plants to butane or other flammable solvents may be done in uncontrolled environments, and as such poses extreme safety risks for extraction of cannabinoids in such a manner

The present disclosure, in an aspect, allows for removal and/or separation of various cannabinoids and/or other chemical compounds from a plant as an essential oil and/or resin. The resulting oil and/or resin may then be separated from the solvent/catalyst and purified to produce a cannabinoid oil and/or resin of a specific cannabinoid. The purified oils may then be combined to create a specific blend of cannabinoids that may be used as a “strain” of cannabinoids that produce specific amounts of pharmacological effects. Although referred to as “cannabinoids” herein, such references should be construed to include any chemical compound that may be derived from the cannabis plants, as well as other chemical compounds which may be derived or extracted from any biomass feedstock, without departing from the scope of the present disclosure.

In an aspect of the present disclosure, the combined oils may be consumed directly. In another aspect of the present disclosure, specific oils and/or combined oils may be sprayed and/or applied onto other materials and/or plants to provide specific increases in pharmacological effects, and/or changes in pharmacological effects, to the other materials and/or plants. For example, and not by way of limitation, a specific combination of oils known to produce euphoria and anti-oxidant effects may be applied to a standardized material, such as a cookie, or to a cannabis plant that may be lacking in some way with respect to those desired pharmacological effects, to provide a more standardized pharmacological effect from a given strain of cannabis and/or material.

Because cannabis has been recently legalized in many jurisdictions, there is a renewed interest in cannabinoid isolation and extraction from various materials. For example, and not by way of limitation, Cannabis is a unique source for a family of functionally active chemicals called cannabinoids. The extent of the specific cannabinoids is recently emerging as a new set of chemical feedstocks, which may be used to produce many functional products. Cannabis plants also yield fibers and/or other biomass material that can be converted into textiles, nonwovens, traditional pulp based stock, biofuels and/or bulk solid materials. These refined cannabis fibers can replace and/or improve synthetically derived fibers that are prevalent in many applications.

Instead of focusing on THC content, cannabis may also be grown and/or hybridized to focus the yield on fiber, flowers, and/or seeds. These hybridized and/or highlighted qualities of the cannabis plant can increase the yield of specific cannabinoids from certain varieties. For example, and not by way of limitation, a cannabis strain that is focused on seed production may be unsuitable for recreational cannabis use, but may increase the yield for product conversion feedstocks.

These mechanical and/or chemical processes, in an aspect of the present disclosure, may be scaled up and/or scaled down to provide efficient use of the cannabis feedstock. For example, and not by way of limitation, in a strain focused on seed production, i.e., a male seed-producing strain, a food-type of feedstock having high concentrations of Omega-3 and/or Omega-6 fatty acids may be produced. The mechanical and/or chemical processes used for refining and/or purification of a pound of such seeds cannot merely be multiplied by 1000 when 1000 pounds of seeds is being processed. In an aspect of the present disclosure, the changes in the parameters and characteristics in the processes used is made more efficient based at least in part on the amount, type, and/or end product desired from any given biomass feedstock.

As another example, and not by way of limitation, a strain focused on the production of flowers, i.e., a female flowering plant strain, extraction, isolation, and/or purification of the family of cannabinoids present in such a strain may be different than the seed-producing strain.

In another aspect of the present disclosure, modified cannabis material, whether partially oxidized, dissolved and re-precipitated, and/or in conjunction with some physical arrangement into a form with another material, may also be employed. These and/or other functionalities that may be unique to cannabis feedstock may also be employed in distillation, sorbents, packed bed columns, filtration, solid/liquid separation, reactive distillation and/or other mechanical and/or chemical operations.

In an aspect of the present disclosure, the control of certain parameters may increase the yield of desired end-product constituents. Such parameters include, but are not limited to: 1) moisture, i.e., the weight percentage of water in the total mass of the plant; 2) particle size; i.e., the maximum dimension of the particle measured by the collection of particles as they pass through a series of calibrated sized screens; 3) processing temperature; 4) processing pressure; 5) concentrations, e.g., measurements that relate to the mass ratio of one constituent to another or the individual constituent to the total mass in the specific sample at a certain point in the process flow; 6) shear rate, i.e., the mechanical energy that is imparted on the particles, liquids, and gasses that exist in different concentrations and physical forms throughout the process of the biomass; 7) viscosity, i.e., the physical separation and purification of the various constituents depends upon the flow properties of the material, which also takes into account the relationship between viscosity and shear rate (rheology) at the point in the process where viscosity is measured; and 8) pH, ORP, O2 and/or other analytically derived specific constituent measurements, where processing of each measured constituent, e.g., pH, may be affected by the ratios of each of these measurable parameters in combination with the concentration of the target constituents.

To control the various parameters listed above, and/or other processing parameters to extract the desired end-product (“desired constituents”), an aspect of the present disclosure may control not only the parameters, but the order in which the parameters are controlled. The order of operation, alone and/or in combination with the controlled parameters, may also affect the scaling of the process equipment to allow certain ratios of control parameters to provide a consistent result independent of the sizing and/or scaling of the processing system.

In an aspect of the present disclosure, an order of processing may be as follows: 1) material collection and/or harvesting; 2) material physical separation and/or trimming; 3) material drying; 4) material grinding and/or milling; 5) slurry making; 6) reaction processes; 7) distillation processes; 8) filtration processing; 9) centrifugation; 10) ion exchange processing; 11) membrane separation of constituents; and 12) packaging. Any order and/or processes, as well as additional or fewer steps within each process, is envisioned as within the scope of the present disclosure.

### Flow Diagram

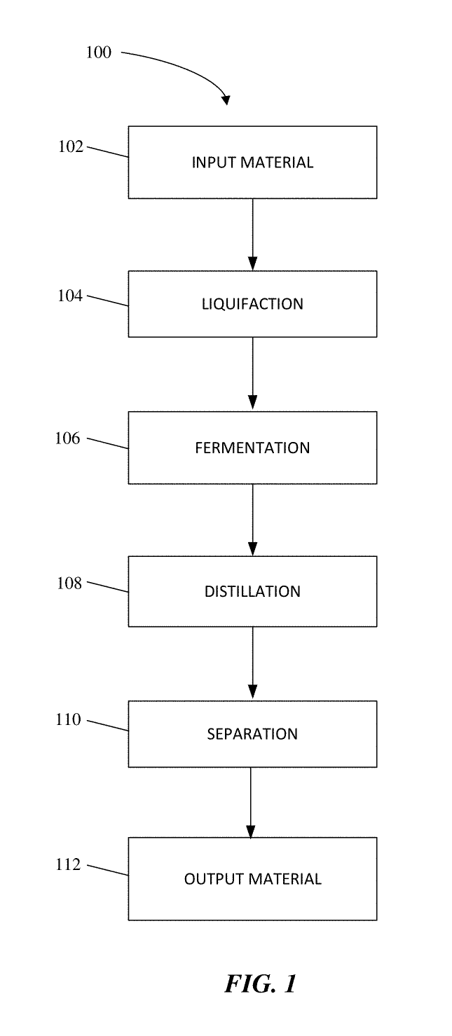

FIG. 1 is a process flow diagram for producing essential oils (which may include cannabinoids, resins, or other biological by-products) in an aspect of the present disclosure.

Process 100 starts with an input material 102. The input material 102 may then subjected to a liquefaction process 104. The liquefied material may then be fermented in a fermentation process 106, and the fermented input material may then be placed in a distillation process 108. The distilled material may then be placed in a separation process 110. The separation process 110 produces an output material 112.

In an aspect of the present disclosure, process 100 begins with an input material 102 comprising cannabis plants and/or cannabis plant matter. The input material 102 may be referred to as a “biomass” or a “feedstock” where large quantities of input material 102 are present. The present disclosure, in an aspect, may employ other input material 102 that contain catalysts which may aid in removal of the desired oils and/or resins from the cannabis feedstock. Further, input material 102 may comprise material that includes additives that may combine with some cannabinoids or other by-products of input material 102 to produce desired oils and/or resins in the output material 112.

Depending on the type of the input material 102 that is used in process 100, the input material 102 may be liquefied and/or glycolized to allow further processing of the input material in later stages of the process 100. For example, if the input material 102 is in solid or semi-solid form, the liquefaction process 104 may convert the solid or semi-solid input material 102 into a form that will be more efficiently fermented in the fermentation process 106 or in later portions of process 100. If the input material 102 is not of a homogeneous nature, the liquefaction process 104 may also homogenize the input material 102, such that the fermentation process has a more uniform effect on the input material 102.

A material in the form of a slurry, liquid, particle, fiber, or block of input material 102 comprising constituents occurring naturally in various cannabinoid containing materials may be separated from the input material 102 in a series of operations. As described with respect to processes 100 and/or 200, separation of essential oils, cannabinoids, or other desired output materials 112 from various other constituents found in the input material 102 may be achieved in an aspect of the present disclosure. The output material 112 created through the process described may also create a feedstock for further isolation and purification operations to present market-ready products and/or products useful for adding to market-ready products.

The input material 102 may be a fluidized solid stream, i.e., a slurry of solid in a gas, a slurry, i.e., a solid intermixed with a liquid carrier, or loose solids that are capable of moving through processes 100 and/or 200. Although referred to as a slurry herein, any input material 102 may be used without departing from the scope of the present disclosure.

Other methods for isolating a cannabinoid species from a biomass containing the species may include the use of various solvents and processes that require stepwise extraction methods. For example, a first solvent may be employed to remove CBC, while a second solvent may be employed to remove CBD. The shortcomings of related approaches are, for example, moving a stream of biomass particles through a physical chamber that is capable of supercritical process conditions. The present disclosure, in an aspect, enables a continuous extraction of one or more desired output materials 112.

One of the weaknesses that other approaches have displayed is the loading of fresh material and the unloading of spent material. In an aspect of the present disclosure, a slurry of biomass particles is created using various solvents that allow the biomass particles to avoid becoming interlocked when subjected to the temperatures and pressures employed for the cannabinoid/oil extraction.

Solvents may include fluids and/or liquids that have the ability to reach supercritical conditions used in processes 100 and/or 200. Examples of such solvents that may be used in aspects of the present disclosure comprise carbon dioxide, ethanol, other alcohols and/or alkanes, etc. The present disclosure envisions that any solvent system, individual or multiple constituent, showing a solvency towards carbon-based biomass may be utilized without departing from the scope of the present disclosure. Further, such solvents may be used in conjunction with other solvents, gases, and/or fluids such that a controlled permeation process with a desired efficacy for solubilizing the desired target species in an aspect of the present disclosure.

Further, solvents may be used in combination, and selected and/or combined at various ratios to enable the slurry movement of the particles and the extraction of the targeted oils through process 100. One or more solvents may also be employed in aspects of the present disclosure in combination with various pressures, temperatures, and various concentrations of solvents to move the slurry as well as to produce the desired output material 112.

The liquefaction process 104 may begin the conversion of the input material 102 into separable oils, resins, and/or cannabinoids. Further, the liquefaction process 104 may aid in the filtration of contaminants and separation that may occur later in the process 100.

In an aspect of the present disclosure, the input material 102 may also require some sort of additional material to aid in the liquefaction process 104, fermentation process 106, or in other processes used in the overall process 100. As such, in the liquefaction process 104, other materials, such as liquification enrichments or other additional materials, may be employed to make the remainder of the process 100 more efficient for the input material 102 being used.

The fermentation process 106 may convert the oils and/or other by-products that are present in the liquefied input material 102 into acids. The fermentation process 106 may be performed by various methods, e.g., bacterial fermentation and/or acid phase anaerobic digestion. Fermentation of the input material may extract certain acids, such as cannabidiolic acid (CBDA), which has an antibiotic pharmacological effect.

In a fermentation process 106 that is an aerobic digestion process, bacteria and/or other microorganisms use oxygen from the surrounding environment. Aerobic digestion may mainly produce carbon dioxide and water from input material 102 that is carbon and oxygen-rich. If the input material 102 contains nitrogen, phosphorus and sulfur, then the aerobic digestion may also produce nitrates, phosphates and/or sulfates.

By controlling the pressure, environment, temperature, input material, particle size of the output material 112, and/or the types of liquification/fermentation/chemical extraction of the input material 102, the present disclosure may accept a large range of input material 102 and still produce a desired output material 112 in a cost-effective and efficient manner

In the distillation process 108, the gaseous products of fermentation process 106 may be removed, and the acids, oils, resins, and/or cannabinoid products of fermentation process 106 may be separated from each other. As these products are separated, each product may be refined, purified, or distilled to increase the percentage of acid(s) in the distillate. The present disclosure encompasses at least one, and perhaps several, output slurries and/or gas flows from the distillation process 108, which may be recombined or may be processed separately depending on the desired output material 112.

The distilled material is then placed in a separation process 110. The separation process 110 provides further separation of desired output materials 112 from the one or more distillates, and may further refine the distillates into various output materials 112 and/or byproducts.

The above description with respect to FIG. 1 is an overview of the extraction process 100. Many variations are possible within this general framework of the process 100. In aspects of the present disclosure, reference is made to the process 100, and which potential portion of the process 100 such variations may occur in. However, the present disclosure is not limited to such portions as discussed herein.

In an aspect of the present disclosure, a desired output material 112 is a material with a high concentration of a specific cannabinoid and/or cannabinoid acid. Although a high concentration of such a cannabinoid may be produced from particular input materials 102, the present disclosure discusses, in an aspect, how to produce a output material 112 having a high concentration of a desired cannabinoid, or any other desired cannabinoid or cannabis by-product, from an input material 102. Depending on the particular input material 102 being employed, variations on the process 100 may be used to produce the output material 112 having the desired concentration of a desired cannabinoid and/or cannabinoid acid, and/or the desired cannabinoids.

For example, and not by way of limitation, a particular input material 102 may require additives to provide the process 100 with a feedstock that can produce the desired output material 112, in this instance, CBC. Further, depending on the type and/or time spent in the fermentation process 106, distillation process 108, and separation process 110, the amount of additives may be increased or decreased. The present disclosure manages the entire process 100, including the input material 102, to produce the desired output material 112 more efficiently for a given input material 102.

Some of the difficulties in the process 100 when used to produce CBC, and/or any cannabinoid, are that the process 100 may be designed for a single, homogeneous input material 102, e.g. a specific strain of cannabis sativa. Even when a single input material 102 is used, the fermentation process 106 may not be well controlled, and as such it is difficult to produce a consistent CBC output material 112 resin having consistent pharmacological properties.

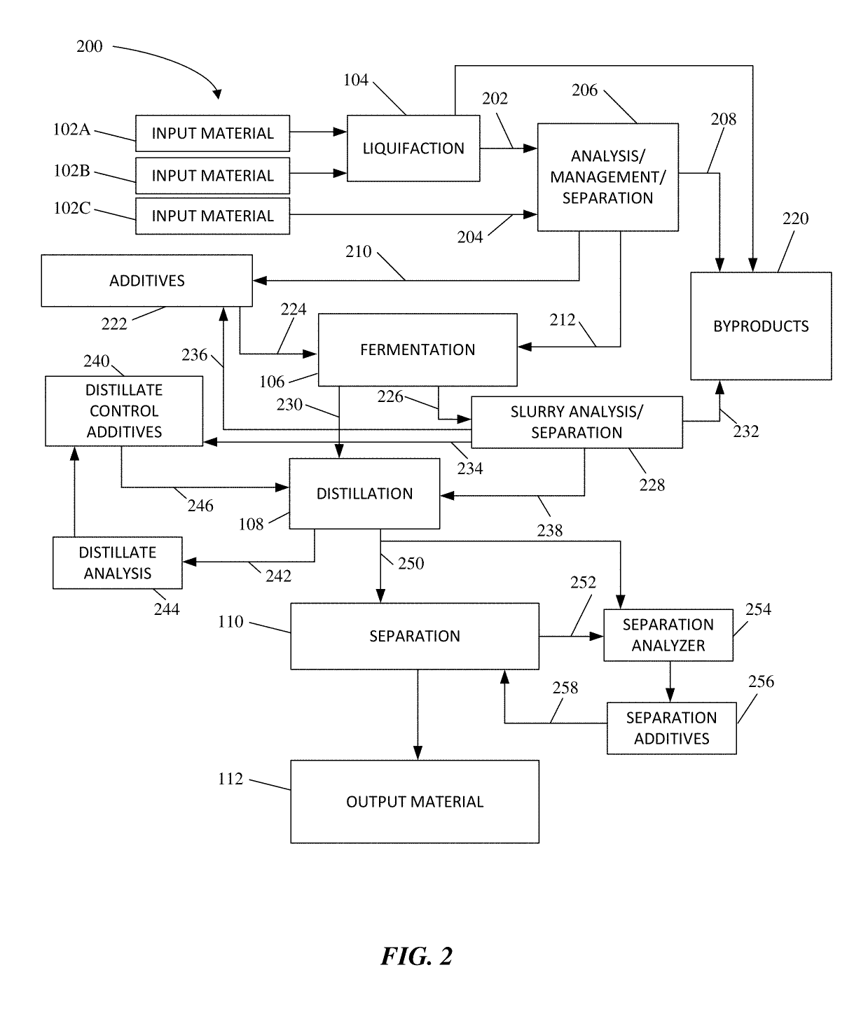

FIG. 2 illustrates a process flow in an aspect of the present disclosure.

In an aspect of the present disclosure, each of the components flowing from one portion of process 200 to another are monitored. This monitoring allows the process 200 to be improved or tailored to a particular input material 102, such that the liquefaction process 104, fermentation process 106, distillation process 108, and separation process 110 can be altered, or additional materials can be added to the overall process 200, to produce a desired output material 112, and/or a desired output material 112 having specific qualities or characteristics.

By controlling each of the processes 104-110 in the process 200 for each individual input material 102, as well as each “batch” of the input material 102 that is placed into the process 200, a more consistent output material 112 may be obtained. Further, as different input materials 102 and different desired output materials 112 are entered into or extracted from the process 200, the process 200 controls and monitoring allow for a wider range of materials to be used in, and produced by, the process 200. Further, a single line of equipment may be used to perform process 200 and still accept various input materials 102 and produce various output materials 112.

### Liquefaction Process

As shown in FIG. 2, different types of input materials 102, shown as input materials 102A, 102B, 102C, may be used as feedstocks for the process 200. Further, depending on the desired process 200, one or more of the input materials 102A, 102B, and/or 102C may be pre-processed prior to the process 200, and more than one of the input materials 102A, 102B, and/or 102C may be used in any combination as inputs to the process 200. The present disclosure is not limited to three input materials 102A, 102B, and 102C; any number of input materials may be used without departing from the scope of the present disclosure.

Depending on the composition of the input material, the process flow may use the liquefaction process 104 to provide a uniform material 202. Otherwise, the input material 102A, 102B, and/or 102C may flow directly as material 204 (which may also be referred to as a slurry) to an analyzer 206. Liquefaction process 104 may use a mechanical homogenization process, a macerator, or other mechanical, electrical, or biological device to provide desired characteristics within the input material 102A-102C. Further, the liquefaction process 104 may be used to provide a more uniform feedstock to the fermentation process 106.

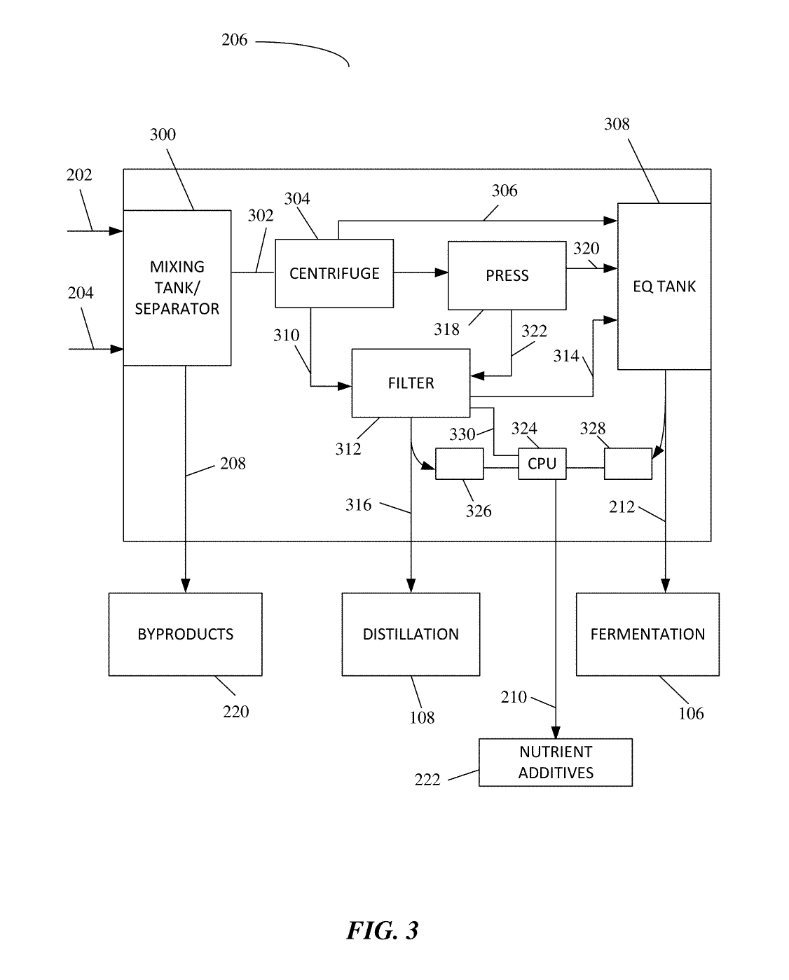

FIG. 3 illustrates an example of an analyzer in accordance with an aspect of the present disclosure.

An example of a mixing tank/separator, also referred to as an analyzer 206, is shown in more detail in FIG. 3 in accordance with an aspect of the present disclosure. The materials 202 and/or 204 may be initially placed in a mixing tank 300. The mixing tank may homogenize the materials 202 and/or 204 if needed into a single mixed material 302. Further, the mixing tank 300 may separate out a flow 208 containing inert materials, such as metals, plastics, and other materials that may not be converted into the output material 112 when subjected to the process 200. The flow 208 is sent from the analyzer 206 to a byproducts container 220 for further separation and/or disposal.

From the mixing tank 300, mixed material 302 is placed in a centrifuge 304 or other device that separates the mixed material 302 by density, weight, size, or other methods of separation. Some outputs 306, which may contain essential oils at this point in process 200, may be directed to an equalization tank 308, as the output 306 may approximate or already be a desired output material of the analyzer 206. Some outputs 310 may still be liquids mixed with some denser or larger material, and may be passed through a filter 312 to separate the liquid from the denser or larger material such that the denser or larger materials form an output 314 that can also be sent to the equalization tank 308. The equalization tank, as well as the rest of the analyzer 206, may be environmentally controlled in temperature, pressure, humidity, or other factors, to increase the ability of the process 200 to extract the necessary acids and other products from mixed material 302. The liquid 316 from the output 310 may also be a desired output of the analyzer 206. The material that forms the output 314 may be sent to distillation process 108.

Still other material 316 from the centrifuge 304 may need to be compressed or otherwise processed in a press 318 to remove additional solids 320 that can be converted into the desired output material 112. After the liquid 316 is pressed, the output 322 from the press 318 may also be filtered in the filter 312.

The filter 312, which may be a particle filter, membrane filter, or electromagnetic filter, allows the process 200, and the analyzer 206, to accept multiple and varied feedstocks (materials 202 and 204) into the process 200. By controlling the size of particles that are separated by the filter 312 contaminants to the process 200 may be strained out, and various different liquids may be separated, that contain different byproducts that may be usable within the process 200. Further, the byproducts can be directed to different places within the process 200, or may be transferred to different machines and/or different processes, because of the variability allowed through the filter 312.

For example, and not by way of limitation, the filter 312 may be used to filter different sizes of acids and/or cannabinoids, some of which have longer chains, for use in different products. Some short chain acids and/or cannabinoids may be used in one process to make an output material 112. Other acids and/or cannabinoids, having longer chains, may be separated using the filter 312 for use in other output materials 112. Further, the filter 312 may be electrically and/or mechanically changed within the process 200 to perform both of these separations, as well as additional separations, as desired.

The equalization tank 308 may also be used to provide a proper balance of solids to liquids to the fermentation process 106. For example, depending on the input material 102 and fermentation process 106, a preferred percentage of solids, may produce the desired output material 112 more efficiently than other percentages of solids when placed in the fermentation process 106.

In an aspect of the present disclosure, the analyzer 206 may include a processor 324, which may be coupled to sampler 326 and/or sampler 328. Sampler 326 monitors and/or samples the liquid 316, to determine if the liquid 316 is ready for distillation process 108. Further, the sampler 326, which provides information to the processor 324, may aid in controlling the distillation process 108, by changing parameters of the distillation process 108. For example, and not by way of limitation, the sampler 326 may determine that the liquid 316 has a concentration of cannabinoids of 1 percent. The processor 324 may then vary the time, heat, pressure, and other factors used in the distillation process 108 to produce a greater or lesser concentration of cannabinoids, and/or desired output, from the distillation process 108.

Further, the processor 324 may accept data or input information from the sampler 328, which monitors the characteristics of the equalization tank 308. In a similar fashion, the processor 324 may alter the parameters of the fermentation process 106 based on the analysis provided by the sampler 328. The processor 324 may also receive input signals from other parts of the process 200, such as analysis of the fermentation process 106 output, distillation process 108, etc., and provide output signals 210 to other parts of the process 200, such as signals to add materials to process 200 from an additive bank 222, increase or decrease fermentation time, etc., to make the process 200 more efficient for the flows of materials 202 and 204. The processor 324 may also send signals 330 to control the filter 312, or to control other portions of the analyzer 206, within the scope of the present disclosure.

As shown in FIG. 3, the analyzer 206 separates the flows of material 202 and/or 204 into various components. From the mixing tank 300, byproducts and/or inert materials may be separated from the overall feedstock. The centrifuge 304, press 318, and filter 312 remove solids from liquids in the feedstock. Liquids may be passed to the distillation process 108, and solids may be sent to the equalization tank 308. Additives may be added to the equalization tank 308 to begin the breakdown of the solid materials if desired. Further, the samplers 326 and/or 328 may be used to sample the liquids and solids, to evaluate the materials being passed to subsequent portions of the process 200. Additives, such as nitrogen, phosphorus, potassium, or other micronutrients may be added to the liquid 316 flow, or the solid flow 212, to increase the efficiency of the overall process 200 and/or to produce a desired output material 112.

Returning to FIG. 2, flow 208 is passed to the byproducts container 220 from the analyzer 206. As discussed above, the byproducts container 220 may receive plastics, metals, or other products that may deleteriously affect the process 200. Output signals 210 based on the analyzer 206 may be sent to the additive bank 222, such that selected additives and amounts may be added to the fermentation process 106. The solid flow 212, from the equalization tank 308, may be added to the fermentation process 106.

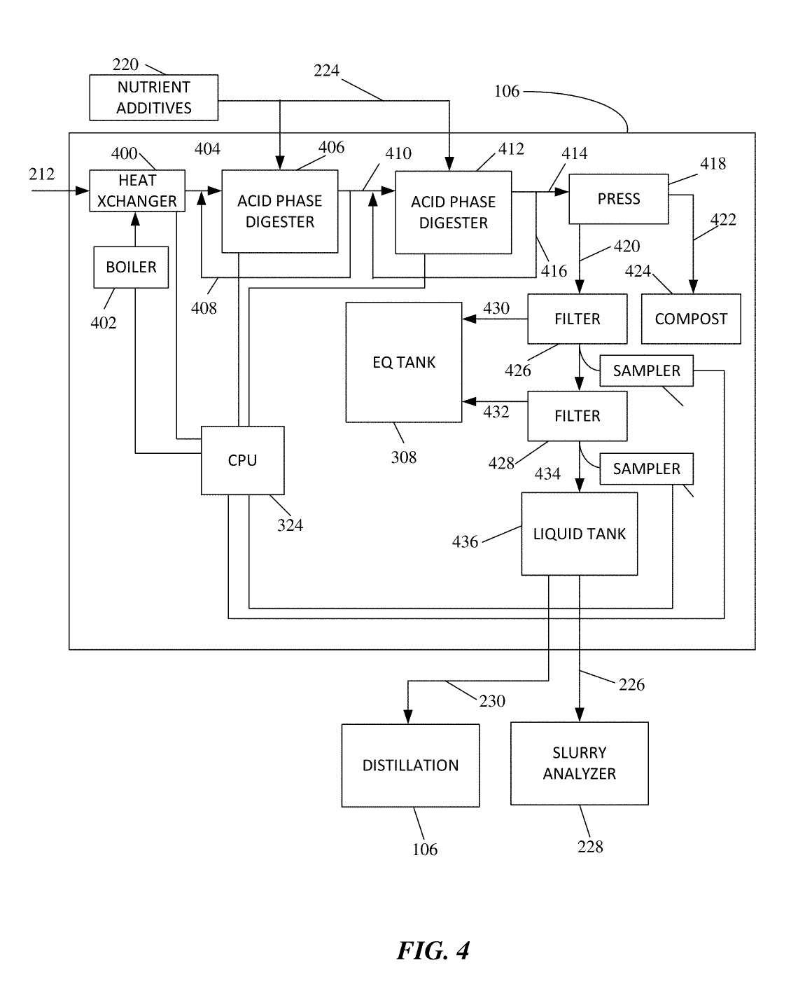

FIG. 4 illustrates the fermentation process in accordance with an aspect of the present disclosure.

In an aspect of the present disclosure, the fermentation process 106 is described in further detail in FIG. 4. Although a fermentation process 106 that is biological can be used in the present disclosure, such as yeast acting upon sugars to produce alcohol, in an aspect of the present disclosure acid-phase anaerobic digestion of the sugars present in the feedstock may be performed. The solid flow 212 may initially need to be placed in a heat exchanger 400, which may receive heat from an electric or other type of boiler 402. Once the output has received sufficient heat, the material 404 is placed in a digester 406, which may be an acid-phase digester, fermenter, hydrolysis tank, or other holding tank as desired. The digester 406 may have a recirculating output 408, that is fed to the input of the digester 406.

The digester 406 may anaerobically digest the material 410 into acids present in cannabis biomass. Because the material 404 may not have included a desired chemical composition, the processor 324 may have sent signals to the additive bank 222, or to an operator, to add specific amounts 224 of certain additives, certain types of solvents, or other additives from the additive bank 222 to the digester 406.

If desired, the material 410 from the digester 406 may be placed into one or more additional digesters 412. Having multiple acid-phase digesters allows the process 200 to employ different types of bacteria, produce different types of volatile acids, or obtain additional material 414 to be used in the output material 112 production. The digester 412 may also have a recirculating output 416 that is fed to the input of the digester 412. As with the digester 406, because the material 410 may not have included a desired chemical composition, the processor 324 may have sent signals to the additive bank 222, or to an operator, to add specific amounts 224 of certain additives, different types of bacteria, etc., from the additive bank 222 to the digester 412.

Each of the digesters 406 and 412 may use different types of processing to digest the materials into soluble acids. Each of the digesters may use batch flow processing, sequential batch processing, continuous processing, or plug flow processing.

Further, each of the digesters 406 and 412 may use different types of bacteria, or may use different types of fermentation to produce different slurries of the input material 102. The material 414 that is output from the digester 412 is sent to a press 418, where liquids 420 and solids 422 are separated. The solids 422 may be used as compost 424, or may be used elsewhere in the process 200, depending on the solids 422 produced at this point of the process 200.

The liquids 420 may then need to be filtered through filter 426 and/or filter 428. The filters 426 and 428 may provide different levels of filtration for the liquids 420. For example, and not by way of limitation, the filter 426 may be an ultrafiltration system, while the filter 428 may be a nanofiltration system. Solids 430 and 432 filtered out of the liquids 420 may be sent to the equalization tank 308, as desired.

The liquids 434, after filtering, may be sent to a tank 436 for holding the liquids 434, or may be sent to slurry analyzer 228, or may be sent directly to distillation process 108.

The liquids 434, as well as the liquid 420 and any other filtered liquid in the fermentation process 106, may contain cannabinoids, volatile fatty acids, and/or other desired solids and/or liquids. The filters 426 and 428, as well as the press 418, provide various opportunities to separate the solids in material 414 from the liquids 420 and 434 within the fermentation process 106. Each of these liquids 420 and 434 (and any other liquid containing cannabinoids and/or desired acids) may be separated, either with filters 426 and/or 428, or other separation techniques, to isolate each of the desired liquids as desired.

To control the presence/absence/concentration, the additive bank 222 may be employed to provide the digesters 406 and/or 412 with ingredients that adjust the cannabinoid and/or acid concentrations. The samplers 440 and 442, which may be coupled to the processor 324 or another processor within the fermentation process 106, may assist in controlling the volatile fatty acid concentrations in the liquids 434 and 420, and thus controlling the cannabinoid and/or acid concentrations in the outputs 226 and 230 from the fermentation process 106.

The solids separated from the digesters 406 and/or 412 may still contain useable material that can be used to produce other cannabinoids and/or other desired output materials 112. Such solids may be processed either within the process 200, or in another process.

### Cannabinoid Extraction

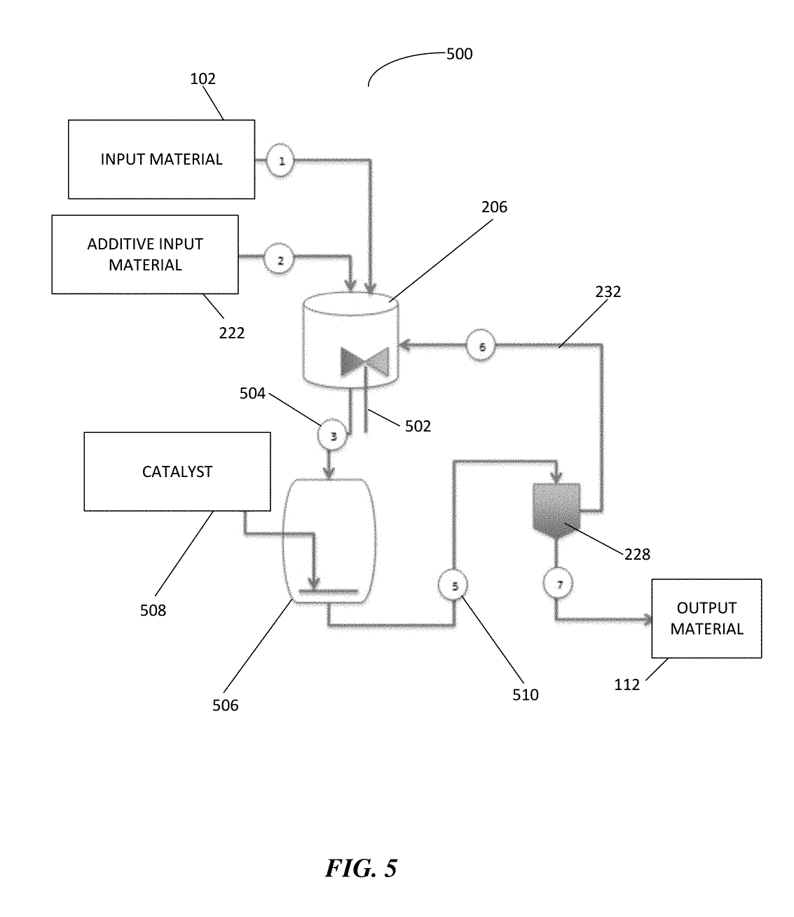

FIG. 5 illustrates a system in accordance with an aspect of the present disclosure.

System 500 shows input material 102 and, optionally, additive input material 222 being input into analyzer 206. A mechanical/electrical impeller 502 mixes the slurry 504 (the combination of input material 102 and additive input material 222) in analyzer 206. At this point, the slurry 502 is more easily moved, as additive input material 222, which may comprise a solvent, is being used as a carrier liquid in this portion of the system 500.

As slurry 504 is moved to reactor 506, some of the carrier liquid portion of slurry 504 may be removed from reactor 506, as having a large ratio of carrier liquid to input material 102 may hinder the physical loading and unloading problems for slurry 504 and may also hinder the extraction effectiveness of the system 500. For example, and not by way of limitation, carbon dioxide gas may be used as an additive input material 222 to pressurize the slurry 504 from analyzer 206 to reactor 506. Once the slurry 504 has been moved to reactor 506, the carbon dioxide gas may be removed from reactor 506 and reaction conditions may be initiated to begin extraction of cannabinoids and/or oils from slurry 504. Residual carbon dioxide in slurry 504 may be used to assist in the extraction.

When in reactor 506, a catalyst 508 may be added to reactor 506. Catalyst 508 may be another solvent, or may be steam, pressure, temperature, or other characteristic that acts upon slurry 504 (and/or additive input material 222) to create a desired reaction within reactor 506. Reactor 506 is configured to produce temperature, pressure, and/or volume constraints on slurry 504 to remove one or more desired cannabinoids from slurry 504.

If desired, a second catalyst 508, and/or a second set of conditions for reactor 506, may be applied to slurry 504 while slurry 504 is present in reactor 506. Such a second catalyst 508 may extract a second cannabinoid from slurry 504, and/or may be employed to further extract additional amounts of the cannabinoid extracted earlier in reactor 506.

In an aspect of the present disclosure, catalyst 508, and/or additive input material 222, may be selected to extract selected cannabinoids, as well as allowing slurry 504 to change from a liquid slurry that is easily transported to a solid slurry that may be more easily processed. By selecting these materials, also referred to as a “solvent set” herein, an aspect of the present disclosure at least partially overcomes the difficulties of moving slurry 504 through system 500. A solvent set for a given desired output material 112 may transform slurry 504 from a liquid slurry carry capacity state which enables loading of the reactor 506 to a supercritical state which enables the extraction of desired output materials, and may also enable and movement of the slurry 504 in a continuous fashion.

As the reaction is completed in reactor 506, slurry 510 may be moved to a separator tank 228, again through the use of solvent set if desired. Slurry 510 may also be flushed from reactor 506 to tank 228 by pressure, additional slurry carrying liquid, or other means. Separator tank 228 may be used to recycle material 232 back to tank 206, or to remove spent solids and/or liquids from system 500, as desired.

Although described with respect to cannabis biomasses, the present disclosure may also be employed with respect to grassy biomasses such as hay, alfalfa, wheat, and other fibrous plants. Grassy biomasses tend to interlock and intertwine during transport, which creates throughput problems for systems 500 without employing aspects of the present disclosure. The slurry 502 formed in an aspect of the present disclosure enables the transport of the grassy biomass into and out of the reactor 506, which assists in a continuous extraction process for a desired output material 112.

This invention will produce an “extracted material” or simply “material” which may be in the form of various states of matter and of various concentrations and relative ratios of the species outlined above. The most prevalent product of this invention will be the unique material made up primarily of various species that will be the feedstock for further refining and purification to produce market ready products.

The material is produced in mixing systems uniquely applied with high shear versus the more common chemical industry batch tanks, columns, and continuous mixed reactors of various configurations. In an aspect of the present disclosure, shear, e.g., the interaction of the biomass (input material 102) and other particles and the liquids and gasses in the reactor 506 environment creates forced dynamic interactions between the biomass and one or more solvents due to the temperature, pressure and physical properties of the various constituents present in reactor 506. This environment exposes the surface areas of the solids, the liquid droplets, and/or the gaseous fluid boundaries to each other, which increases the probability of interactions between the solvent(s) and the input material 102. The shear of the present disclosure helps enable the mass transfer (i.e., extraction of desired output materials 112) in conjunction with the temperature and pressure in reactor 506. The shear may be imparted by mechanical means within reactor 506, e.g., via an agitation device and/or by fluid dynamic means, which may adopt one or more physical configurations of piping, pressure chambers, and/or cavities defined by the physical arrangement of pipes and tanks throughout the system.

Further, the interaction between input material 102 and solvents may be increased by “shearing” input material into smaller pieces. In an aspect of the present disclosure, this shear may be accomplished through friction between particles in the fluid stream, friction with the particles hitting some stationary portion of the piping, and/or through mechanical energy additions to the slurry, e.g., agitators, ultrasonics, rotor/stator mixers, pitched blades, etc.

The process 200, at least through the samplers 326, 328, 440, and 442, may have automated (via the processor 324) or manual monitoring and adjustment of the process materials to ensure the consistent production of the output material 112 having the desired material properties. The process 200 samples materials throughout to measure concentrations of additives and/or output materials and then calculates the supplemental material to add to or dilute the process material in order to achieve a desired recipe for consistent material properties in the output material 112. Some materials that are created, or are byproducts of, the process 200, may be inhibitory to the anaerobic digestion process of the digesters 406 and/or 412. For example, and not by way of limitation, citrus culls and rots represent a good feedstock for the production of PHA resins, but limonene, and other essential oils present in a citrus cull feedstock, may inhibit the anaerobic digestion process. The process 200 recaptures these essential oils as a by-product of the process 200, which also aids in the efficiency of the process 200 overall.

### Extraction Example

For example, and not by way of limitation, a feedstock (input material 102) may be a specific strain of c. sativa, “Purple Haze,” e.g., c. sativa Thai×c. indica Dutch “Skunk” The feedstock may be sheared into smaller pieces with a grinder, chopper, or other mechanical device to allow the input material to have a larger surface area for the solvent to contact the input material 102.

The sheared input material 102 may then be mixed with a solvent, e.g., liquid ethanol, such that the mixture of input material 102 and solvent (now called a “slurry”) may move through the system and be exposed to desired portions of process 100 and/or 200. The ratio of input material 102 to solvent may be determined by weight percent (wt %), efficiency of the solvent used, reactor 506 conditions, or other parameters, including the ability of the slurry to move through the system and process 100 and/or 200.

The size of the solids (e.g., particle size) in input material 102 may also be controlled as a parameter for consideration in process 100 and/or 200. The particle size of input material 102 may assist in the ability of a particular solvent to extract a desired output material 112, in combination with temperature, pressure, and/or specific constituents present in reactor 506 during extraction. The surface area to solvent ratio, and the ability of solvents to interact with input material, may provide additional efficiencies within an aspect of the present disclosure.

For example, a 30 wt % to 70 wt % slurried input material 102 may operate between 100 psig and 10000 psig in a temperature range of 30 degrees F. to 200 degrees F. in the system. The particle size of the input material 102, in such an example, may have the solid portion of the slurry mass be filtered between a 325 mesh (44 microns) and 10 mesh (2000 microns or 2 mm) Rates of extraction of such a slurry, and the yield of extraction, can be tuned to extract specific constituents present in the slurry using different extraction solvent make ups. Processor 512 may control the temperature and pressure, while monitoring the amount of output material 112 produced, to increase the efficiency of the process 100 and/or 200.

In reactor 506, extraction conditions, e.g., temperature, pressure, wt %, additional solvents, and/or other parameters are arranged to allow the solvent(s) to attain a supercritical state. In other words, the solvent(s) in supercritical states begin to efficiently (or more efficiently) remove the desired output material 112 (e.g., CBC) from the input material 102 solids. The reaction can be controlled to increase the amount of CBC (or other oils) removed from the input material 102 feedstock, and the solute (CBC, or other desired output material 112) is then removed from the liquid either through filtration or other methods (centrifuge, mass separation, magnetic/electric fields, etc.). The output material 112 may be selected by particle size, and the reactor 506 conditions may be selected to determine the particle size(s) desired as output materials 112.

Once the output material 112 is separated from the slurry, the slurry can then be separated into solids (which may act as another input material 102), gases (which may be another output material 112), and fluids (which may be the remaining solvent). These can either be recycled alone or in combination to be processed again through process 100 and/or 200, have the fluids removed for re-use in the system on other input materials 102, and/or the solids can be processed using another solvent to remove other output materials 112 from the solids (which are another input material 102 at this point). The separation of solids, fluids, and/or gases may be performed at any time during process 100 and/or 200 without departing from the scope of the present disclosure.

Each of the solids, fluids, and gasses remaining in the slurry after output material 112 may act as another input material 102. Further, each of the remaining solids, fluids, and gasses remaining in the slurry after output material 112 may be recycled as a solvent, processed as waste, or used elsewhere in process 100 and/or 200 without departing from the scope of the present disclosure.

If the input material 102 is a different strain of c. sativa, then the reactor 506 parameters may have to change to extract CBC from that strain. Further, if a different output material, e.g., a different essential oil, such as CBD, is to be extracted in reactor 506, different solvents, reactor 506 conditions, etc., may be employed to extract the different desired output material 112.

In the present example, it can be seen that processor 512 may control one or more aspects of process 100 and/or 200. As process 100 and/or 200 is being performed, processor 512 may monitor reaction time, temperature, pressure, amount of solute obtained, solute percentages, etc., and may change these parameters during one or more portions of process 100 and/or 200 to increase efficiency. Further, processor 512 may store the parameters of a given process 100 and/or 200 for a given input material 102, and such parameters may be adjusted, stored, saved in memory, etc., until the process parameters create a higher efficiency process for extraction within the system. Further, the particle size of output material 102 may be monitored and/or verified by processor 512 to determine the extraction efficiency of process 100 and/or 200.

As can be seen with the above example, there can be more than one reactor 506 within the system to allow for the extraction of different solutes from a given input material 102. Further, multiple solutes may be extracted in a single reactor 506, depending on the solvent, reactor 506 conditions, etc. Any combination of multiple solvents, multiple solutes, different input materials 102, multiple reactors 506, etc., are possible without departing from the scope of the present disclosure.

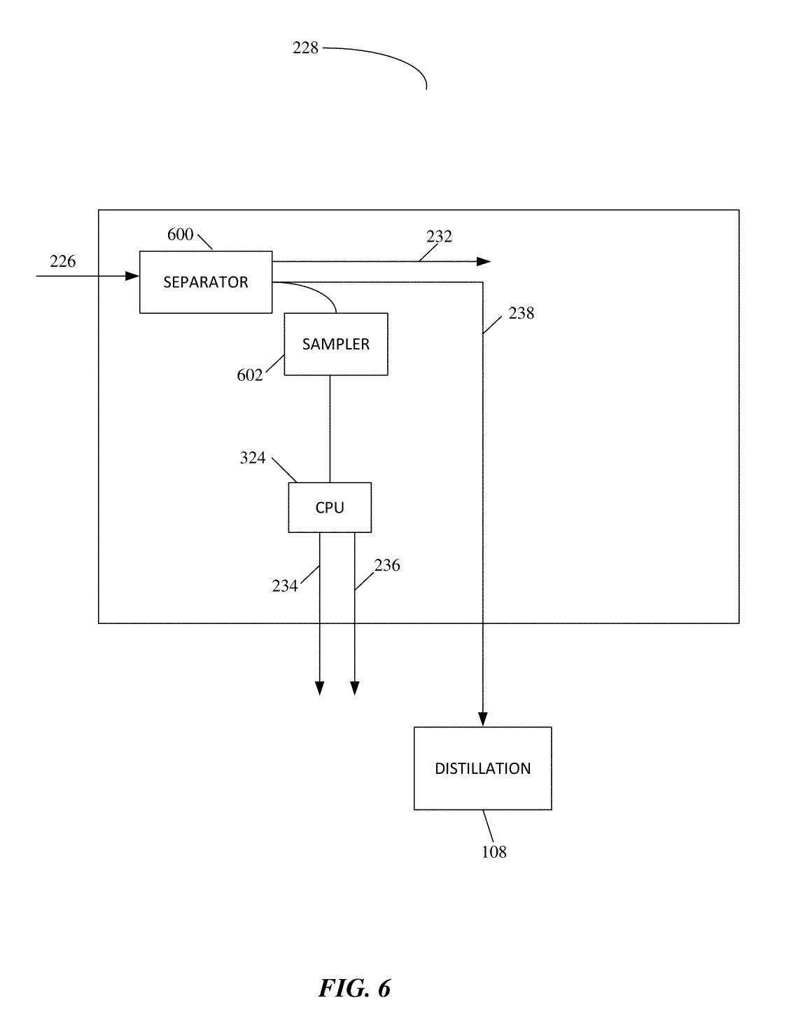

FIG. 6 illustrates a slurry analyzer 228 in accordance with an aspect of the present disclosure. Slurry analyzer 228 accepts output 226 from the digester 406, and separates the incoming material in separator 600. Separator 600 may, for example, separate a specific cannabinoid from the acids and send that cannabinoid as a byproduct via 232. Other separations may be done by separator to separate individual acids from the output 226.

To separate each acid, or one output of the slurry analyzer 228 from another, a sampler 602 samples the output stream 238. This may be analyzed electronically through the processor 324, or manually, as desired. The processor 324 may send signals 234 and/or 236 to control the additive bank 222, or the distillate control additives 240, to control other parts of the process 200. These signals may be administered manually by an operator if desired.

Referring again to FIG. 2, the distillation process 108 may also be analyzed, either electronically or manually, to determine the concentration of acids in the distillate product 242. The analysis 244 may be similar to those analyses described with respect to FIGS. 3-5. The analysis 244 may also provide inputs to the distillate control additives 240 to provide inputs 246 that change the distillation process 108, such as pressure, temperature, steam or other vapor use, etc.

The output stream 238 is also sent to distillation process 108, which has a cannabinoid broth 250 as an output used during the separation process 110. The cannabinoid broth 250 prior to separation, or a separation stream 252 that may be analyzed during or after separation, may be sent to separation analyzer 254. The separation analyzer 254 examines the separation stream 252 and/or cannabinoid broth 250, and determines, either chemically, visually, or through other analyses, to determine whether or not the separation process 110 is producing the desired output material 112. If not, the separation analyzer 254 may, either independently or through the processor 324, control separation additives 256 to add materials 258 to the separation process 110, in order to produce the desired output material 112.

The separation analyzer 254 may use a microscope, camera, spectrophotometer, or other device, and software or other comparison tools, to compare a sample of the cannabinoid broth 250 and/or the separation stream 252 to a known sample of material. Through visual, chemical, or structural comparison of the cannabinoid broth 250 and/or the separation stream 252, the separation analyzer may alter the separation process 110, or other portions of the process 200, to more closely match the cannabinoid broth 250 and/or the separation stream 252 to the known material. This comparison may be done in real-time to control the process 200 during operations. For example, and not by way of limitation, CBC concentration may be measured by sampling the cannabinoid broth 250 with a chemical analyzer. Recognition software or other recognition methods may identify a concentration of CBC or other cannabinoids present in the broth 250.

Further, the separation analyzer may also determine other characteristics of the broth 250 and/or the separation stream 252, such as the percentage of weight of the cells in the material, percentages of other cells in the material, etc. This information can then be stored for later analysis, or placed in records for each batch of materials being produced, or may be used as a trigger to stop the production process when a desired CBC concentration or other material properties are reached. The separation analyzer may also use different wavelengths or different sensors to determine the percentage of different cannabinoids to allow for additional analysis of the broth 250 and/or the separation stream 252.

The output of the separation process 110 is the desired output material 112. The output material 112 may also be analyzed to determine if other characteristics of the process 200 may be changed to increase the efficiency of producing the desired output material 112. Further, the analysis of the input material 102, the automated and/or manual changes made to the process 200, and the chemical and structural properties of the output material 112, may all be stored and/or recorded such that future processes 200 may be tailored using the changes made to the process 200 for a particular batch of input material 102.

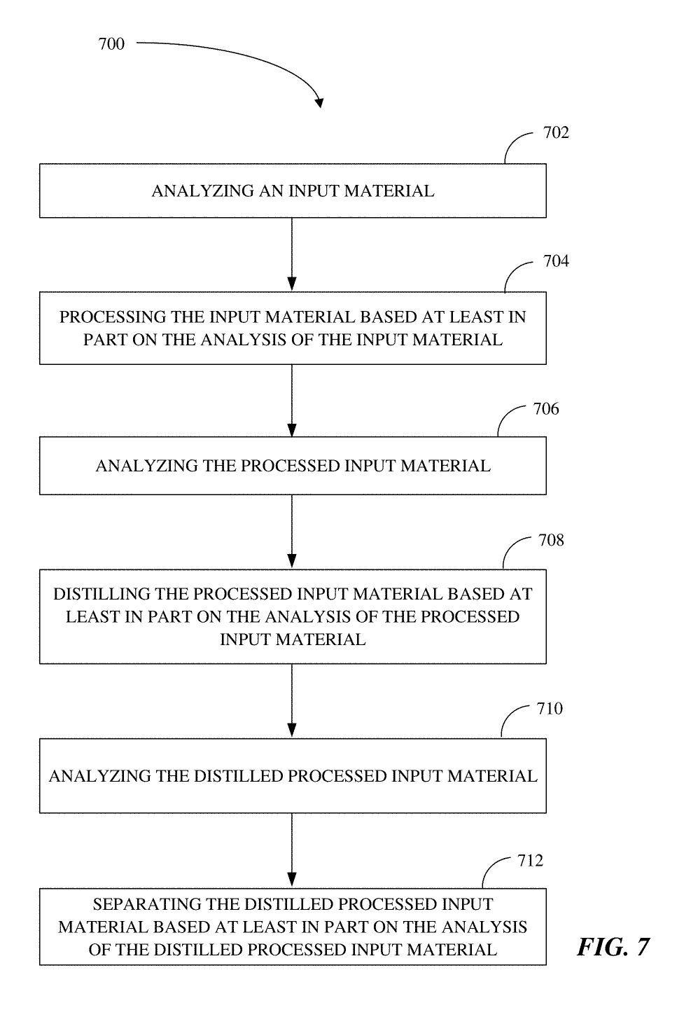

FIG. 7 illustrates a process flow diagram illustrating a method 700 for producing oils in accordance with an aspect of the present disclosure. In block 702, an input material is analyzed as shown in FIGS. 2 and 3. In block 704, the input material is processed based at least in part on the analysis of the input material, as shown in FIGS. 2, 3, and 4. In block 706, the processed input material is analyzed as shown in FIGS. 2 and 4. In block 708, the processed input material is distilled based at least in part on the analysis of the processed input material as shown in FIG. 2. In block 710, the distilled processed input material is analyzed as shown in FIG. 2. In block 712, the distilled processed input material is separated based at least in part on the analysis of the distilled processed input material as shown in FIG. 2.

### Processing Example

As an example of a processing flow, and not by way of limitation, a strain of cannabis may be planted and cultivated that increases seed production in male plants. The seeds may be processed into a food supplement and/or food stuff product that is rich in Omega-3 and Omega-6 fatty acids.

To process thousands of acres of such a crop, a small-scale processing operation may be employed in an aspect of the present disclosure. For example, a one acre parcel may be used to determine the particular characteristics of the overall crop; this process is often referred to as “feedstock characterization.”

The one acre of crop may be collected and the seeds may be separated from other parts of the plant. The seeds may be dried to reduce moisture content. The dried seeds may then be ground or otherwise reduced in size and mixed with other liquids and/or solids into a slurry. The slurry may be fermented and/or distilled, and then filtered through various sized filters to remove the constituents of the slurry. The slurry may again be dried and/or moisture removed, or the slurry may be otherwise purified for packaging.

The order and/or time for each process in the feedstock characterization run through the system 100 may be changed when larger, smaller, and/or continuous processing takes place. For example, the seed drying time may be reduced or increased depending upon the effect of residual moisture in later processing steps. By measuring and/or controlling various parameters throughout the system 100, e.g., measurement and/or control of various parameters at each unit operation, a data set of parameters and/or controls may determine the performance of the system 100. As such, system 100 would produce a desired product: moisture, particle size, temperature, pressure, concentration, shear rate and analytics. The feedstock characterization processing run may assist in determining the basis upon which to scale other sized processing, e.g., larger and/or smaller amounts of feedstock, to produce the same end-product from system 100.

### Vacuum Distillation of Extracted Cannabis Oil for Separation of Constituents

Oils that are extracted from cannabis feedstock often contain multiple cannabinoids. In an aspect of the present disclosure, each cannabinoid may be isolated, separated and purified. However, the viscosity of the extracted oil is often very high. High-viscosity materials are difficult to distill because the phase change boundary that enables the chemical reactions of distillation requires a high localized temperature. The high temperature may change the chemical structure of the desired end-product. As such, a smaller yield of the desired end-product, additional reactions based on temperature of the desired product into other products, and/or other undesired reactions may occur because of the higher temperatures required.

In an aspect of the present disclosure, vacuum distillation may be employed to mitigate the effects of increasing the temperature. By reducing the pressure at the phase boundary, the amount of thermal energy used to change the phase of the separating species is also reduced. Therefore, the desired end-product may be produced with the desired molecular structure. Further, reducing the pressure at the phase change boundary does not significantly reduce the viscosity of the solution being processed. As such, an increased shear rate, along with the vacuum distillation, may be used to reduce the viscosity for better fluid flow through system 100. The combination of vacuum distillation and increased shear rate may be referred to as “wiped film vacuum distillation.”

Because the combination of reduced pressure, reduced temperature and increased shear rate is favorable to many specific constituents at the phase boundary, the control of these parameters may allow for various desired separations of cannabinoids from such a slurry.

### Cannabis Functional Material

In another aspect of the present disclosure, cannabis feedstocks may be separated into functional particles for other processes. For example, and not by way of limitation, functional particles can be used as packing for distillation columns, sorbent for adsorbing columns, and/or integrated into fibers and/or membranes for membrane separation. Cannabis char has significant absorbency and species retention qualities, similar to wood and other biomass char. However, cannabis char shows a propensity to behave like inorganic sorbents, which have a different set of functional properties than organic sorbents. As such, cannabis char may be added to other chars to add inorganic sorbent qualities to various organic sorbents for any sorbent application.

For example, and not by way of limitation, fatty acid methyl ester, commonly known as biodiesel, has a processing sequence that makes sulfur and residual glycerine removal difficult. Cannabis char has a greater affinity for species like sulfur than other sorbents that are currently used. Another example is the removal of heavy metals from brines. Lithium containing brines are the most economical feedstock for lithium species, however many resources are hindered by the presence of heavy metal constituents rendering the lithium recovery expensive and hazardous. Cannabis char has shown an affinity for heavy metals to a greater extent than the existing sorbent technology, cannabis char can be applied to remove heavy metals from the lithium containing brine thus reducing the extraction difficulty for lithium. Although described with respect to biodiesel, any fatty acid functional methyl ester and/or fatty acid functional material may be processed within the scope of the present disclosure.

Another example of an aspect of the present disclosure is the incorporation of cannabis char into a polymer matrix. The incorporation may allow the formation of fibers and/or membranes to insert into existing physical fiber and membrane separation systems, which may expand the functional separations of these existing devices. Arsenic is a concern in drinking water. Cannabis char can be incorporated into existing systems to capture arsenic from an incoming water stream. Cannabis char may also be employed as a particle and/or in conjunction with organic or inorganic co-species in other filtration devices. The cannabis char can be used in conjunction with and/or instead of granulated activated carbon.

In an aspect of the present disclosure, a mobile version of system 100 may be assembled to enable custom processing of the various field harvests. Because the present disclosure, vis-a-vis system 100, controls metrics and parameters throughout the processing of the biomass, system 100 may be mounted on a truck and/or other vehicle and/or trailer to move system 100 where the harvesting is taking place.

The arrangement of system 10 may be controlled, by controlling the parameters described herein, to produce desired end-products based upon the parameters present in the harvested biomass. For example, and not by way of limitation, if the product desired has a particle size range of 150 microns to 250 microns as determined by the material balance on a mesh screen stack (passing 60 mesh, retained on 80 mesh) this particle size determines an amount of surface area on the particles of the material that influences the downstream unit operations. By determining the performance of the extraction, separation or distillation based on the particle size distribution defined, the arrangement of the downstream operations can be tailored to specifically apply the equipment in the unit.

By controlling one or more of the deterministic variables, and arranging the system for smaller scale operating parameters, operating parameters for larger and/or different scales of the process may be established.

### Ethanol Extraction

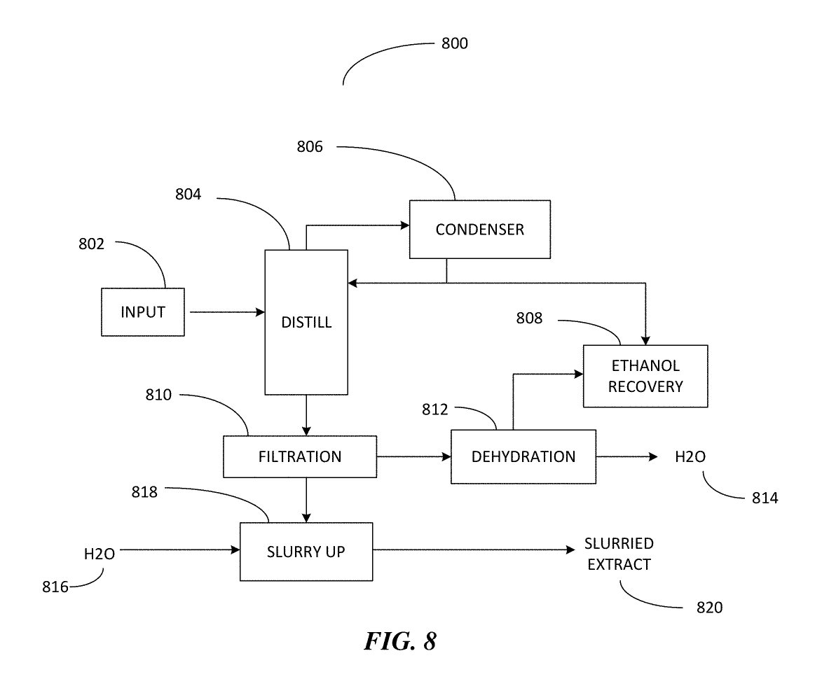

FIG. 8 illustrates a process flow for extraction of ethanol in accordance with an aspect of the present disclosure.

System 800 has an input 802 feeding a distillation column 804. Input 802 may be a dissolved cannabis and/or hemp strain that has been ground, where the solvent is one or more alcohol, alkane, ester, ether, and/or combination of various solvents. Solvent recovery may be performed via distillation column 804. Extracts from hemp and/or cannabis may be complicated because many of the extracted constituents precipitate or create increasingly viscous materials that hinder the physical flow properties in the distillate bottoms. However, in an aspect of the present disclosure, upstream parameter control manages the parameters in input 802 to allow for distillation in distillation column 804.

Condenser 806 condenses the ethanol and passes the ethanol to ethanol recovery tank 808. Other liquids from the distillation column 804 may be filtered in filter 810 and passed to a dehydrator 812 to remove water 814. The resultant liquids may be added to ethanol recovery tank 808. The filtered solids may have water 816 added in a slurry tank 818 to create a slurried extract 820.

Although ethanol is shown as the desired end-product/constituent extracted, many other end-products/constituents may be extracted from the input material and/or input without departing from the scope of the present disclosure. Other alcohols, fatty acids, cannabinoids, functional materials, fatty acid functional materials, and/or other extracts may be produced, using the described and/or other processes, without departing from the scope of the present disclosure.

### 3D Printing

In another aspect of the present disclosure, cannabis and/or hemp extracts may be used in three-dimensional (3D) printing applications. 3D printing employs various resins and/or curing agents to produce three-dimensional designs from computer input files. Many of the resins used in 3D printing are derived from petrochemicals and have hazardous elements throughout the supply chain in their coming to the user. Resins derived from cannabis may reduce the hazardous processing and/or nature of such products used in the 3D printing market.

3D printing operates by fusing deposited material onto a surface in layers. A low melting point material is layered in a controlled way allowing the material to harden quickly after placement retaining the desired shape directed by a placement device. In this technology, polylactic acid is emerging as a natural alternative to the more common acrylonitrile butadiene styrene (ABS), however many different polymers can be applied to the technology. Cannabis contains the building block materials that can be converted into polylactic acid.

A second technology is emerging as a useful and novel technique for 3D printing. By combining the techniques of stereolithography and photopolymerization, a “build from the bottom” technique is emerging on the market. Resins are used in a pool and a light of a focused wavelength and shape is precisely positioned in the pool creating the desired shape of the object being built. The curing rate by the photopolymerization by the particular wavelength light is specific to the resin being used.

Cannabis contains many different fatty acids, which may be useful in stereolithography as employed in 3D printing. A desired specific fatty acid blend may be reacted with an oxidizer, e.g., hydrogen peroxide, and then heat may be added at a defined mixing and shear rate for a specific time. This blend of base and reagents may then be reacted with a strong mineral acid, which may be photopolymerized in a 3D printing application. During the reaction sequence, the composition ratios, mixing, shear, temperature and reaction time all can be adjusted to change the properties of the desired photopolymer to change the cure time, the curing wavelength, the viscosity, the density and the final desired hardness and toughness properties of the 3D printed part.

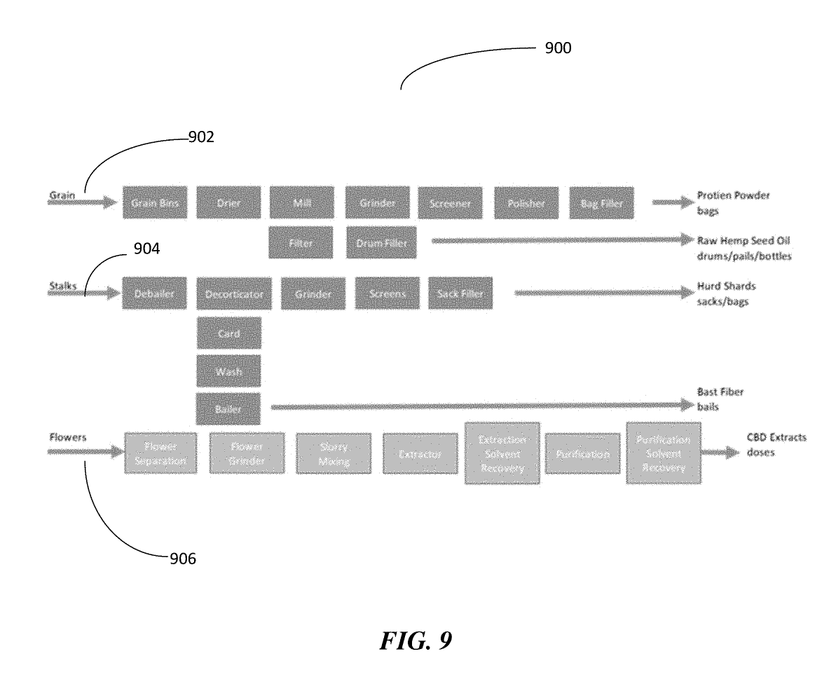

FIG. 9 illustrates separate processing steps for different constituent parts of a biomass in accordance with an aspect of the present disclosure.

Process flow 900 illustrates that different processes and/or steps may be taken for various constituent parts of a given biomass. For example, and not by way of limitation, grain portions of a cannabis and/or hemp plant (and/or any other biomass) may follow process 902, which may include drying, milling, grinding, screening, polishing, and packaging for protein powder bags, and which may include other steps such as filtering and/or drum filling for raw seeds and/or bulk oils and/or products. Process 904, which may be applied to the stalks of plants, may include debailing, decorticating, screening, and grinding to create hurd shards as end-products, while other parts of process 904 may include carding, washing, and bailing to create bast fiber bails as end-products. Process 906 may be applied to flowers, and such process 906 may include separating, grinding, slurrying, extracting, and purifying such end-products as oils and/or other extracts from cannabis and/or hemp biomasses. As shown in FIG. 9, each process 902-906 may comprise one or more end-products, which may change the steps and/or processes undertaken within process 902-906. Other steps and/or processes within processes 902-906 are possible without departing from the scope of the present disclosure.

For a firmware and/or software implementation of the present disclosure, such as with respect to the processor 324, the methodologies described may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Although the present disclosure and its advantages have been described in detail, it should be understood that various changes, substitutions and alterations can be made herein without departing from the technology of the disclosure as defined by the appended claims. For example, relational terms, such as “above” and “below” and/or “inside” and “outside” are used with respect to a specific device. Of course, if the device is inverted, above becomes below, and vice versa. Additionally, if oriented sideways, above and below may refer to sides of a device. Further, reference to “first” or “second” instances of a feature, element, or device does not indicate that one device comes before or after the other listed device. Reference to first and/or second devices merely serves to distinguish one device that may be similar or similarly referenced with respect to another device.

Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The description of the disclosure is provided to enable any person skilled in the art to make or use the disclosure. Various modifications to the disclosure will be readily apparent to those reasonably skilled in the art, and the generic principles defined herein may be applied to other variations without departing from the spirit or scope of the disclosure. Thus, the present disclosure is not intended to be limited to the examples and designs described herein but is to be accorded the widest scope consistent with the principles and novel features disclosed herein. Accordingly, the disclosure is not to be limited by the examples presented herein, but is envisioned as encompassing the scope described in the appended claims and the full range of equivalents of the appended claims.

What is claimed is:

1. A method for processing biomass, comprising:
analyzing an input material;
processing the input material based at least in part on the analysis of the input material;
analyzing the processed input material;
distilling the analyzed process input material based at least in part on the analysis of the processed input material;
analyzing the distilled processed input material; and
separating the analyzed distilled processed input material based at least in part on the analysis of the distilled processed input material.

2. The method of claim 1, wherein the input material is a cannabis strain.

3. The method of claim 2, further comprising changing at least one of the processing, distilling, and/or separating based at least in part on an amount of input material to be processed.

4. The method of claim 2, further comprising filtering at least one of the processed input material, the distilled processed input material, and the separated analyzed distilled processed input material.

5. The method of claim 4, further comprising changing the filtering based at least in part on at least one of the analyzing of the input material, the analyzing of the processed input material, and the analyzing of the distilled processed input material.

6. The method of claim 2, wherein the processing comprises separating the input material into at least two components of the input material.

7. The method of claim 2, wherein the separated analyzed processed input material is a cannabinoid.

8. The method of claim 2, wherein the separated analyzed processed input material is a food stuff.

9. The method of claim 2, wherein the separated analyzed processed input material is at least one of an alcohol and a fatty acid functional solvent.

10. The method of claim 2, wherein the separated analyzed processed input material is a three-dimensional printing material.

11. The method of claim 2, wherein the separated analyzed processed input material is a cannabis functional material.

12. A system, comprising:
a first analyzer for analyzing an input material;
an apparatus for processing the input material based at least in part on an output of the first analyzer;
a second analyzer for analyzing the processed input material;
a distiller for distilling the analyzed process input material based at least in part on an output of the second analyzer;
a third analyzer for analyzing the distilled processed input material; and
a separator for separating the analyzed distilled processed input material based at least in part on an output of the third analyzer.

13. The system of claim 12, wherein the input material is a cannabis strain.

14. The system of claim 13, in which a parameter for at least one of the distiller, the apparatus, and the separator is changed based at least in part on an amount of input material to be processed by the system.

15. The system of claim 13, further comprising a filter for filtering at least one of the processed input material, the distilled processed input material, and the separated analyzed distilled processed input material.

16. The system of claim 13, wherein the apparatus separates the input material into at least two components of the input material.

17. The system of claim 13, wherein the separated analyzed processed input material is a cannabinoid.

18. The system of claim 13, wherein the separated analyzed processed input material is a food stuff.

19. The system of claim 13, wherein the separated analyzed processed input material is at least one of an alcohol and a fatty acid functional solvent.

20. The system of claim 13, wherein the separated analyzed processed input material is at least one of a three-dimensional printing material and a cannabis functional material.
